(19) United States
(12) Patent Application Publication
(10) Pub. No.: US 2025/0322415 A1
(43) Pub. Date: Oct. 16, 2025

(54) SYSTEM AND METHOD FOR AUTOMATED ASSESSMENT OF SALES TRANSACTIONS

(71) Applicant: Adrata, Inc., PHOENIX, AZ (US)

(72) Inventors: Ross Sylvester, Phoenix, AZ (US); Thomas Curzon, PHOENIX, AZ (US); Allison Duquette, SCOTTSDALE, AZ (US)

(21) Appl. No.: 18/632,119

(22) Filed: Apr. 10, 2024

(51) Int. Cl. G06Q 30/0201

(52) U.S. Cl. CPC G06Q 30/0201

(57) ABSTRACT

The invention presents an advanced expert intelligence system for generation of assessments and recommendations for sales opportunities based upon CRM data, and automated supplementation of CRM data therewith. Implemented on a network-connected computing platform, the system retrieves, cleanses and vectorized structured and unstructured CRM data. Such data for historical sales opportunities may be utilized to train or fine-tune one or more of the models. Models may include micro models, macro models, machine models, human expert models and ensemble models. Assessment components may then be fed back into a CRM platform.

### TECHNICAL FIELD

The present application pertains to computing systems and methods, and more particularly, expert systems for automated assessment of sales transactions and automated supplementation of records within a CRM computing system.

### BACKGROUND

In the realm of Customer Relationship Management (CRM), the vast quantities of data generated, captured and omitted through sales interactions pose a significant challenge. Traditional CRM platforms offer robust databases that store and organize data characterizing sales opportunities and sales team member interactions, such as contact records, opportunity summaries, sales team member activities, call transcripts, email communications, and opportunity notes. However, the sheer volume and complexity of this data often exceed the analytical capabilities of human sales professionals and their managers. Challenges lies not only in the storage and retrieval of data, but also in the timely and meaningful interpretation, evaluation, and actionable utilization of the data to drive sales success. When such challenges impair system users from deriving value out of CRM platform use, users may be disincentivized from thoroughly and consistently recording data in the platform, which may in turn reduce value available from use of the platform.

Human analysis of CRM data is typically time-consuming, prone to errors, and inherently limited by cognitive biases and the finite processing capacity of the human brain. Managers and sales teams must sift through copious amounts and varieties of data in an effort to, e.g., identify patterns, forecast outcomes, and strategize their next actions. This process is not only labor-intensive but also offers limited predictive accuracy, as it often fails to fully leverage latent patterns and deep insights embedded within the diverse CRM data, to the extent such data is captured.

Existing automated systems, such as may be implemented directly within typical CRM platforms, may provide various types of reporting and dashboards. However, existing systems are limited in their ability to provide dynamic, predictive insights into sales opportunities. They may lack sophistication required to extract meaningful insights from disparate types of data. Insight derived from existing systems and methods for managing sales teams and sales pipelines may also be highly prone to inaccuracy stemming from cognitive biases, social pressures and disparate incentives amongst sales team members and their managers. As a result, even highly skilled sales teams may find themselves unable to accurately and consistently predict such vital business information as likelihood of sales opportunity closure, likely time to close, or the potential revenue a sales opportunity might generate.

Implementation of CRM platforms within a company is also typically a lengthy and costly endeavor, requiring extensive planning, implementation, integration with other systems, and user training. Many factors may go into selection of a CRM platform, with each platform providing different benefits and disadvantages. Platforms optimized for some factors, may not be optimized for business intelligence features. Also, CRM platforms may be purchased via long term contracts. Therefore, companies may be reluctant to switch CRM platforms once implemented, and platforms selected in the past may reveal new limitations as a company's business and the state of technology progress.

In light of these challenges, there is a clear and present need for an advanced expert intelligence system that integrates with, supplements and transcends the capabilities of current CRM platforms in order to provide automated, unbiased, clear, accurate and accessible insight into sales opportunities quickly, efficiently and in near real time.

### SUMMARY

In some aspects, the techniques described herein relate to an expert intelligence system for automated assessment of interactions between one or more members of a sales team and prospective customers, and methods for operation thereof. CRM interface logic retrieves data from a network-connected CRM computing platform, including e.g. records characterizing sales team member activities associated with one or more sales opportunities. Such data may be stored by the expert intelligence system within a data store, before or after being parsed cleansed. In some embodiments, the data is vectorized, before being applied to a plurality of data models to generate and output an automated assessment of each of said sales opportunities. The plurality of data models may include a macro model predictive of, and configured to calculate, various automated assessment components such as time until close and opportunity revenue; and a micro model predictive of when a sales opportunity will change state within a predetermined sales pipeline model. The calculated assessment components may then be fed back into the network-connected CRM computing platform for storage and access by e.g. individual users, and/or reporting systems.

In some aspects, the techniques described herein relate to an expert intelligence system, in which: the data cleansing logic is further configured to output a sales opportunity vector by vectorizing a subset of the CRM data associated with a particular sales opportunity; and evaluation logic is further configured to apply the sales opportunity vector to one or more of said data models.

In some aspects, the techniques described herein relate to an expert intelligence system, wherein the CRM data includes contact records, opportunity summaries, sales team members, call transcripts, email communications and opportunity notes.

In some aspects, the techniques described herein relate to an expert intelligence system, wherein the data models include: one or more human expert models having predetermined fixed weights, for recommendation of actions to promote a positive change of state within a predetermined sales pipeline model.

In some aspects, the techniques described herein relate to an expert intelligence system, wherein the data models include: one or more machine models trained via machine learning based on historical CRM data; one or more human expert models having predetermined fixed weights, for recommendation of actions to promote a positive change of state within a predetermined sales pipeline model; and an ensemble model having weights determined at least in part based on outputs from the one or more machine models and the one or more human expert models.

In some aspects, the techniques described herein relate to an expert intelligence system, further including application logic configured to periodically train one or more of said data models based on updated historical CRM data retrieved from said network-connected CRM computing platform.

In some aspects, the techniques described herein relate to an expert intelligence system, wherein the evaluation logic applies the cleansed CRM data to the data models on a periodic basis.

In some aspects, the techniques described herein relate to a method for automated generation of sales opportunity performance assessments, by a network-connected sales support computing platform, for one or more sales opportunities associated with a sales team, the method including: retrieving historical CRM data by a network-connected first computing platform, from a network-connected second computing platform including a CRM, the historical CRM data including a plurality of transaction records, each transaction record associated with a sales opportunity and characterizing an activity undertaken by a sales team in connection with an associated sales opportunity; the historical CRM data further including a success indicator associated with each of said sales opportunities indicating whether each of the completed sales engagements was successful; vectorizing the historical CRM data on a per opportunity basis to generate, and store on the first computing platform, vectorized historical CRM data; training a plurality of machine learning models using the vectorized historical CRM data, each of the models predictive of future events in connection with a sales opportunity, the models including: a macro model predictive of sales opportunity time until close and opportunity revenue; and a micro model predictive of when a sales opportunity will change state within a predetermined sales pipeline model; retrieving, from the second computing platform, current CRM data including records associated with one or more in-process sales opportunities; vectorizing the current CRM data to generate, and store on the first computing platform, vectorized current CRM data; calculating, by the first computing platform, a plurality of automated assessment components by: applying the vectorized current CRM data to the macro model to generate macro sales opportunity data indicative of predicted time until close and predicted opportunity revenue for the one or more in-process sales opportunities, and applying the vectorized current CRM data to the micro model to generate predicted pipeline change data indicative, for each of the one or more in-process sales opportunities, of predicted state change within a predetermined sales pipeline model; and supplementing the current CRM data within the second computing platform by transmitting, for each of said in-process sales opportunities, from the first computing platform to the second computing platform, said macro sales opportunity data and said predicted pipeline change data, for storage by the second computing platform within one or more fields associated with said in-process sales opportunities.

In some aspects, the techniques described herein relate to a method, further including: for each in-process sales opportunity, applying (a) current CRM data records associated with the in-process sales opportunity, and (b) the calculated deal features associated with the in-process sales engagement, to a large language model to output a natural language performance assessment for each of said in-process sales opportunities.

In some aspects, the techniques described herein relate to a method, wherein the step of supplementing the current CRM data includes transmitting, for each of said in-process sales opportunities, from the first computing platform to the second computing platform, the natural language performance assessment.

In some aspects, the techniques described herein relate to a method, further including: applying a subset of the current CRM data associated with a first salesperson, and the natural language performance assessments for in-process sales opportunities associated with the first salesperson, as inputs to a large language model, to generate and store by the first computing platform an overall performance evaluation for the first salesperson.

### BRIEF DESCRIPTION OF THE FIGURES

The invention and the following detailed description of certain embodiments hereof may be understood by reference to the following figures:

FIG. 1 is a schematic block diagram of a computing platform, in accordance with an exemplary embodiment.

FIG. 2 is a flow chart of a process for implementing an automated expert system.

FIG. 3 is a flow chart of a process for training an automated expert system.

FIG. 4 is a schematic block diagram of a data model for generating assessment outputs based on vectorized CRM data.

FIG. 5 is a schematic diagram of a sales pipeline model.

FIG. 6 is a flow chart of a process for applying the trained models to current opportunity data for automated opportunity assessment.

### DETAILED DESCRIPTION

The following examples illustrate embodiments and aspects of the invention. It will be apparent to those skilled in the relevant art that various modifications, additions, substitutions, and the like may be performed without altering the spirit or scope of the invention, and such modifications and variations are encompassed within the scope of the invention as defined in the claims which follow. The following examples do not in any way limit the invention.

An expert intelligence system may be implemented to analyze structured and/or unstructured data that is stored within and/or generated by a customer relationship management (CRM) platform used by, e.g., a team of sales professionals, in order to provide automated assessments of e.g. individual sales opportunities, an aggregate sales pipeline, and sales professional performance.

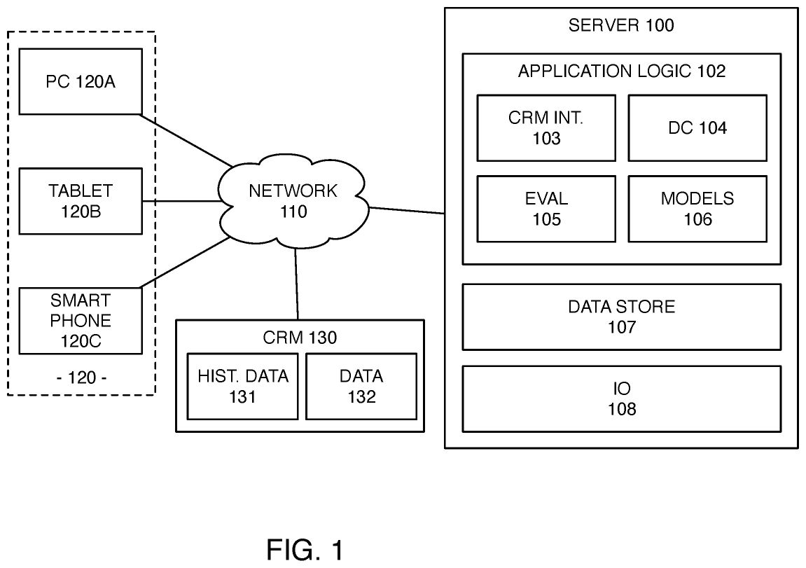

FIG. 1 is schematic block diagram of an embodiment of such a system, in accordance with an exemplary embodiment. Server 100 communicates, inter alia, via computer network 110, which may include the Internet, with user devices 120 such as personal computer 120A, tablet computer 120B and smart phone 120C. While certain illustrated embodiments are implemented using devices such as personal computer 120A, tablet computer 120B and smart phone 120C, it is contemplated and understood that embodiments may additionally or alternatively be implemented using any sort of user computing device providing a user interface suitable for conveying information of the types disclosed herein.

Server 100 implements application logic 102, and operates to store information within, and retrieve information from, data store 107. The term “data store” is used herein broadly to refer to a set of one or more indexed stores of data, whether include structured or not, which may without limitation relational databases, document databases and vector databases. IO logic 108 provides one or more mechanisms for interactions between server 100 and other devices or systems. IO logic 108 may include, for example, an Internet web server, an email server, messaging servers and/or Application Programming Interfaces (APIs) enabling outside interaction between server 100 and, amongst other things, application logic 102 and data store 107.

Application logic 102 is configured to implement a variety of functions described herein. Application logic 102 includes, inter alia, CRM interface logic 103, data cleansing logic 104, evaluation logic 105, and data models 106, each of which is described in further detail below.

Preferably, CRM platform 130 is a network-connected CRM platform operating independently from server 100, but having an API or other mechanism for automated communication of information between CRM platform 130 and server 100. CRM platform 130 stores, amongst other things, historical CRM data 131 and current CRM data 132. Historical CRM data 131 is data associated with past sales opportunities, such as some which have resulted in a sale and others which have not. Current CRM data 132 is data associated with a current sales opportunity. In some contexts, sales professionals may use the term “opportunity” to refer to sales relationships having reached a particular threshold level of activity or qualification. However, it is contemplated and understood that in various embodiments described herein, the term “opportunity” may be used to describe a prospective customer relationship at any stage of a sales pipeline, which in some embodiments may include unqualified leads.

While depicted in the schematic block diagram of FIG. 1 as block elements with limited sub elements, as known in the art of modern web applications and network services, server 100 and CRM platform 130 may be implemented in a variety of ways, including in a distributed computing environment where tasks are performed by remote processing devices that are linked through a communications network. In a distributed computing environment, program modules may be implemented in either or both local and remote computer storage media including memory storage devices. That said, the implementation of server 100 and CRM platform 130 will typically include, at some level, one or more physical servers, at least one of the physical servers having one or more microprocessors and digital memory for, inter alia, storing instructions which, when executed by the processor, cause the server or platform to perform methods and operations described herein.

In some embodiments, server 100 interacts with user devices 120 to render a user interface, enabling communication of information to users of devices 120 and interaction between user devices 120 and server 100. Examples of user interfaces may include, inter alia, a mobile app graphical user interface rendered on a touch-sensitive display screen of a smartphone; or a web application rendered on web browser software running on a personal computer equipped with a keyboard and mouse. However, additionally or alternatively, server 100 may be utilized to generate automated assessments, evaluations and insights that are then uploaded back into records within CRM platform 130, with users consuming and acting upon such information via interactions with CRM platform 130.

CRM platform 130 may preferably be implemented using an Internet-connected CRM platforms that provide API access to company data, such as Salesforce, Hubspot or the like. However, it is contemplated and understood that in some embodiments, CRM platform 130 may include any computing platform that exposes to server 100 the type of sales opportunity data described herein. Such systems may include, for systems, general purpose databases, Microsoft Exchange servers, Discord servers, or the like.

In yet other embodiments, CRM platform 130 may be implemented using multiple network-connected data systems to which server 100 may connect. For example, IO logic 108 may include logic configured to retrieve data from and push data to a conventional CRM platform such Salesforce, while as additionally obtaining other sales-related data from, or pushing data to, an ERP or accounting platform, and syncing email communications directly from an email platform. Thus, depiction of CRM platform 130 as a single block element is intended to provide a figurative reference to network-connected information systems, and should not be deemed to limit implementation of CRM platform 130 to a single information system.

Preferred embodiments may implement server 100 as a system that communicates with, but is otherwise independent from, CRM platform 130. Such embodiments permit interaction of server 100 with a wide variety of CRM platforms and other network-connected information systems. However, it is contemplated and understood that in other embodiments, the systems and methods disclosed herein as being embodied or performed by server 100 may be implemented directly within a CRM platform. For example, application logic 102, data store 107 and IO logic 108 may be implemented within a common computing platform as CRM platform 130, such as via multiple processes running on common microprocessor devices or on physically-separate servers communicating within a common intranet.

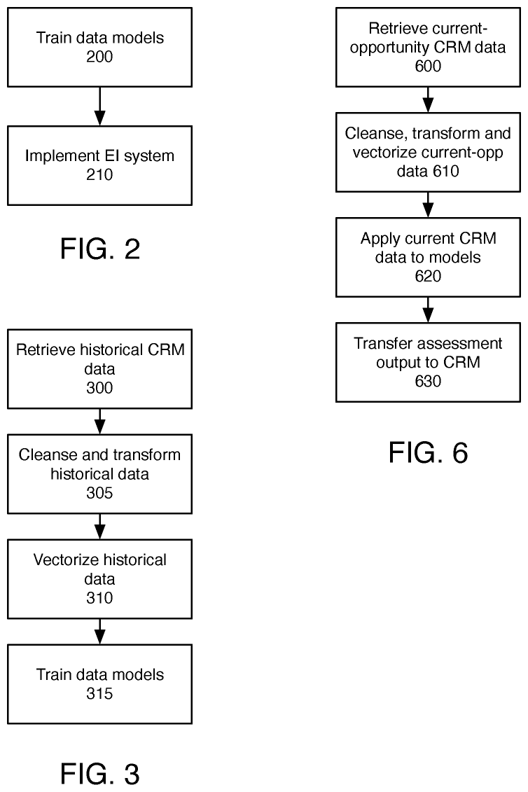

FIG. 2 illustrates an exemplary process for initial implementation of an expert intelligence system for automated assessment of sales opportunities. In step 200, data models 106 are trained. In step 210, server 100 is utilized for automated assessment of sales opportunities.

FIG. 3 illustrates one exemplary embodiment of step 200 for training data models 106. In step 300, CRM interface logic 103 retrieves historical CRM data 131 associated with sales transactions from CRM platform 130, and stores the data within data store 107.

In some embodiments, data models 106 are trained in step 200 at least in part using data associated with historical sales opportunities for a particular company using server 100. In this manner, if server 100 is utilized by multiple different companies, or sales teams within a company, data models 106 may be tuned and maintained on a per-company and/or per-sales team basis. In other embodiments, it may be desirable to train or fine-tune data models 106 based on sales data procured across multiple different companies or sales teams. In some embodiments, it may be desirable to train data models 106 using data from a subset of companies or sales teams. A variety of criteria may be used to select data for training data models 106 for use by a particular company, such as data from companies or teams within a common industry, within a common product category, having a similar sales team structure, targeting a common customer profile, or the like. Thus, while historical CRM data 131 may include data stored within CRM platform 130, it is also possible that historical CRM data 131 may include data stored and/or procured elsewhere, such as other CRM platforms, ERP systems, messaging platforms, or the like. Such data relating to sales opportunities, regardless of the system or systems from which the data is obtained, is referred to herein as CRM data. As such, particularly where CRM data is sourced from multiple network-connected information systems, historical CRM data 131 may be aggregated and maintained by an operator of server 100.

The historical CRM data 131 retrieved in step 300 may include a variety of information associated with a particular sales opportunity, including, without limitation: whether or not the opportunity closed successfully; when the opportunity closed; the actual and/or anticipated revenue size; product details; lead names and details; information concerning relevant contacts; call notes or transcripts; deal or opportunity notes; and email messages and/or other communications. Historical CRM data 131 may include structured and unstructured data.

In step 305, data cleansing logic 104 transforms historical CRM data 131 by, e.g., cleansing the data, and then vectorizing the cleansed data. Operations in step 305 may include standardizing data formatting, deduplication, handling missing data, filtering outliers and noise, data type conversions, error correction, normalization and encoding, dealing with irregular or unnecessary data, text data cleaning, and structuring of unstructured data.

In step 310, the cleansed data output from step 305 (or some proper subset thereof) is vectorized by data cleansing logic 104 into a high-dimensional vector. Preferably, the data is vectorized on a per-opportunity basis, with resulting vectors stored in data store 107.

In step 315, one or more machine learning models are trained using the vectorized historical CRM data generated in step 310. Sales opportunities may involve particularly complex dynamics. Use of vectorized data to create a high-dimensional model of a sales pipeline may uncover nuance that a human expert knows but cannot express, or does not realize. Further, different characteristics of a sales opportunity may be most effectively evaluated using different data models, each optimized for a particular type or set of assessments. Therefore, preferably a blended and multi-layered approach is utilized, in which models optimized for a particular component of an automated assessment are applied based on the nature of assessment component, with one or more other models aggregating outputs from multiple first-layer models to synthesize further automated assessment content. For example, output from individual first layer models may comprise calculated automated assessment components that can be included directly within an aggregated assessment output for a particular sales opportunity, and/or fed into an ensemble model to calculate and generate further automated assessment components based at least in part upon a synthesis of the multiple the first layer model outputs.

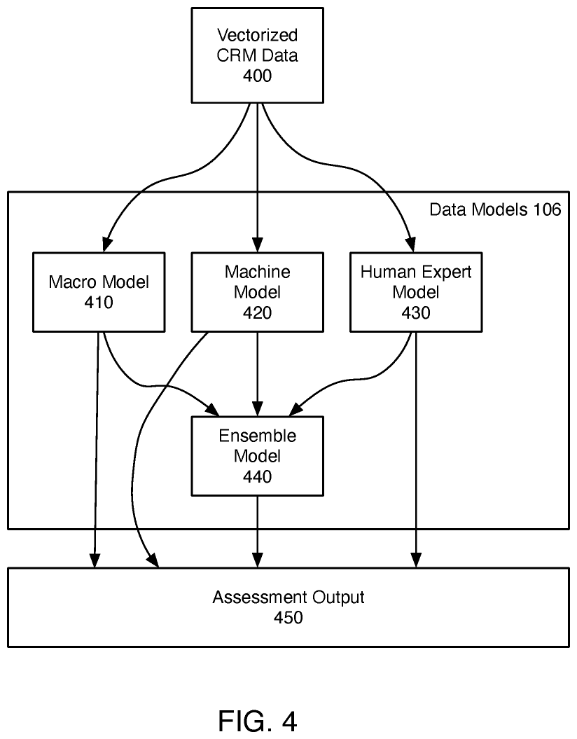

FIG. 4 provides a schematic illustration of a sales opportunity assessment data model structure for training in step 315, and subsequent application for automated assessments (e.g. in step 620, described below). Vectorized CRM data 400 (which may be vectorized historical data such as is generated in step 310, or vectorized current opportunity data as generated in step 610) is fed into a plurality of first layer models, including: macro model 410, machine model 420 and human expert model 430. Outputs of the first layer models can then optionally be fed into one or more second layer models (e.g. in FIG. 4, ensemble model 440).

In some embodiments, a macro model such as macro model 410 will be trained to be predictive, for a given sales opportunity, of macro-level assessments of the sales opportunity as a whole, such as predictive assessment concerning when a sales opportunity will close, the likelihood of a sales opportunity closing successfully (i.e. resulting in a sale), and/or the projected revenue resulting from a successful closing. Macro model 410 may include components implementing machine learning algorithms; components based on static weights, filters, criteria, or the like; or combinations of both.

Machine model 420 is a purely machine-learning trained model configured to assess when a particular sales opportunity will change its current state within a predetermined sales pipeline model, based on the present state of the sales opportunity (i.e. as represented by vectorized CRM data). It is believed that machine learning-based models with high dimensionality inputs are particularly effective for that assessment. Machine model 420 may, for example, be trained based on learned correlations between vectorized CRM data and particular changes in sales pipeline state.

In some embodiments, ensemble model 440 (or another second-layer or higher-layer model) may include a large language model configured to output a natural language assessment based on one or more of current CRM data 132 and/or automated assessment components output from preceding-layer models such as macro model 410, machine model 420 and human expert model 430. Such natural language assessments may be generated by the large language model to, for example, summarize the state or recommended actions for a particular sales opportunity; summarize state of a group of sales activities; and/or summarize the performance of a given sales professional across multiple opportunities with which the professional has interacted.

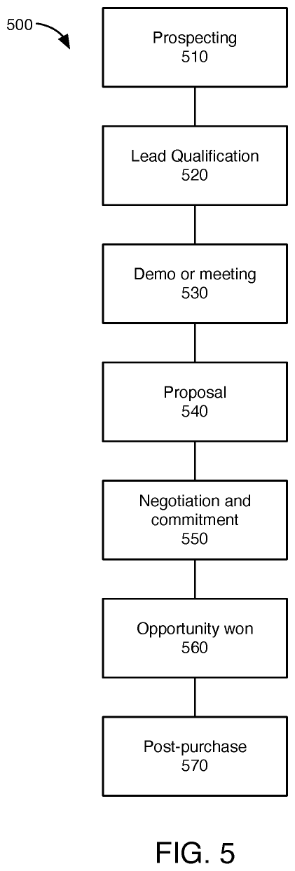

FIG. 5 illustrates an exemplary sales pipeline model 500 which may be used as a framework for state changes predicted by machine model 420. Sales pipeline model 500 includes the following states: prospecting state 510, lead qualification state 520, demo or meeting state 530, proposal state 540, negotiation and commitment state 550, opportunity won state 560 and post-purchase state 570. While FIG. 5 illustrates an exemplary sales pipeline model, it is contemplated and understood that different models may be utilized in different embodiments. In some embodiments, models may have ancillary paths that are not purely linear in nature. In some embodiments, greater and fewer numbers of states may be utilized. In some embodiments, different sales teams or companies may utilize different pipeline models, wherein one or more of data models 106 may be trained based on a specific desired sales pipeline model.

Human expert model 430 provides an alternative model for assessing when a transaction is likely to change state within sales pipeline model 500, and what actions are required to move a sales opportunity forward to a later stage in exemplary sales pipeline model 500. Human expert model 430 is configured at least in part using expert insight, e.g. with fixed weights predetermined by sales experts based on correlation of sales activity with a positive change of state within a sales pipeline model, towards identifying sales team member activities that promote such a positive change.

Ensemble model 440 receives output from machine model 420 and human expert model 430 to synthesize an aggregate assessment output. In some embodiments, ensemble model 440 is a human-in-the-loop tuned model. A human-in-the-loop implementation of ensemble model 440 may be initially trained using human expert review and evaluation of model output. Subsequently, ensemble model 440 may be periodically tuned (and/or retrained) using human expert review and evaluation of model output.

One or more of data models 106 may also output an indication of whether vectorized CRM data 400 comprises sufficient information regarding a particular sales opportunity in order to generate desired automated assessment information with a sufficient level of confidence. For example, in some implementations, certain sales team members may enter data into CRM platform 130 with sufficient thoroughness, accuracy and diligence for data models 106 to generate assessments or recommendations with a desired degree of confidence or accuracy, such as by logging every note, recording detailed information about meetings or calls, consistently tagging data within CRM platform 130, maintaining complete contact records, and the like, enabling data models 106 to perform highly in generating output. Other sales professionals may exercise less diligence in usage of CRM platform 130, such that data models 106 may not have sufficient information upon which to generate one or more of the desired assessments or recommendations—or data models 106 may not have sufficient information upon which to generate one or more of the desired assessments or recommendations with a high level of confidence. In such circumstances, data models 106 may be configured to output an indication of whether assessments can be made at all, or made with a desired threshold level of confidence or quality. Such indications may provide valuable context for interpretation of data model output. Such indications may also be utilized by system users to prompt for supplementation of CRM data within CRM platform 130 for a particular opportunity (or, in some cases, by a particular sales team member).

Once data models 106 are trained, they can be used to implement automated assessments of current sales opportunities. FIG. 6 illustrates an exemplary process for that. In step 600, CRM data for current opportunities may be retrieved from CRM platform 130. Analogously to steps 305 and 310, in step 610 the current-opportunity CRM data may be cleansed, transformed and/or vectorized. Processes and data cleansing, transformation and/or vectorizing mechanisms applied in step 610 to current opportunity CRM data is preferably similar or identical to processes and mechanisms applied to historical CRM data in step 305. For example, the dimensionality of vectorization in step 610 is preferably the same as the dimensionality of vectorization in step 310, so that new data presented to a trained model is in substantially the same format as data used to train the model.

In step 620, vectorized current CRM data associated with a particular current sales opportunity is applied to trained data models 106 to generate automated assessments of the current sales opportunity (i.e. assessment output 450), including macro-level assessments (estimated time to close, expected revenue), and micro-level assessments (e.g. when the opportunity is likely to transition to a different sales pipeline stage). FIG. 4 illustrates an exemplary arrangement in which assessment output 450 is aggregated from outputs of first layer models (macro model 410, machine model 420, human expert model 430) and a second layer model (ensemble model 440). However, it is contemplated and understood that alternative arrangements can be utilized. For example, to the extent that machine model 420 and human expert model 430 are configured to evaluate the same sales opportunity parameters using different models, it may be desirable to feed output from machine model 420 and human expert model 430 only into a second layer model such as ensemble model 440, and not include outputs from machine model 420 and human expert model 430 directly within assessment output 450.

Once an automated assessment of a current sales opportunity has been generated in step 620, in step 630, the assessment output may be transferred back to CRM platform 130. For example, server 100 may utilize IO logic 108 to transmit assessment output 450 back for storage within CRM platform 130. In particular, data items within assessment output 450 may be populated into fields within a CRM platform 130 data store, for an associated current sales opportunity. Assessment output 450 may then be accessed as needed by e.g. other users of CRM platform 130, or by automated reporting or further assessments implemented directly by CRM platform 130.

In some embodiments, training step 200 and automated assessment step 210 may be performed on-demand, and/or periodically over time at various intervals. For example, it may be desirable to train, or fine tune, models 106 periodically over time based on new CRM data developed over time by a user, sales team, company, or across companies. Training of models 106 may be performed, e.g., nightly, weekly, monthly, quarterly, semi-annually or annually, by training logic within application logic 102. Historical CRM data 131 may be updated over time (e.g. re-retrieved from CRM platform 130 and stored within data store 107) to reflect sales opportunities that have closed during the course of using server 100 and application logic 102. Similarly, assessment step 210 may be performed by application logic 102, for example, nightly, with server 100 pulling fresh CRM data CRM from platform 130, cleaning, parsing and vectorizing the updated CRM data, and applying the updated CRM data to data models 106 in order to generate updated assessment output 450. Updated assessment output 450 may then be fed overnight back into CRM platform 130 by IO logic 108, such that users of CRM platform 130 can view updated automated assessment details when they begin working the following day.

The automated assessments and recommendations generated by the systems and methods described above may, in some embodiments, be useful for supplementing CRM platform data and providing additional metrics for e.g. business performance and sales team guidance, in a format and environment optimized for ease of use by sales team members. Further, by enabling sales team members to extract more value from CRM platform 130 with less effort, the systems and methods described herein may incentivize such users to use CRM platform 130 more diligently, and maintain better data within it, thereby creating a virtuous cycle yielding yet better quality output from the systems and methods.

The above disclosures and descriptions are exemplary in nature, and not intended to limit the scope of the invention. Any person skilled in the art given the present disclosures could design variations and additional embodiments of the same invention based on these disclosures, which are all covered by this application for letters patent.

Although some of various drawings illustrate a number of logical stages in a particular order, stages which are not order dependent may be reordered and other stages may be combined or broken out. Alternative orderings and groupings, whether described above or not, may be appropriate or obvious to those of ordinary skill in the art of computer science. Moreover, it should be recognized that the stages could be implemented in hardware, firmware, software or any combination thereof.

Unless defined otherwise, all technical and scientific terms used herein have the same meaning as those commonly understood to one of ordinary skill in the art to which this invention pertains. Although any known methods, devices, and materials may be used in the practice or testing of the invention, the methods, devices, and materials in this regard are described herein.

### Some Selected Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which the term or phrase pertains. The definitions are provided to aid in describing particular embodiments of the aspects described herein, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

Other than in the operating examples, or where otherwise indicated, all numbers expressing quantities used herein should be understood as modified in all instances by the term “about.” The term “about” when used in connection with percentages may mean ±18, unless another meaning is suggested or appropriate in view of the context in which the term is used.

In embodiments of the disclosure, terms such as “about,” “approximately,” and “substantially” may include traditional rounding according to significant figures of the numerical value.

The singular terms “a,” “an,” and “the” include plural referents unless context clearly indicates otherwise. Similarly, the word “or” is intended to include “and” unless the context clearly indicates otherwise. Thus, for example, references to “the method” includes one or more methods, and/or steps of the type described herein and/or which will become apparent to those persons skilled in the art upon reading this disclosure and so forth.

Although methods and materials similar or equivalent to those described herein may be used in the practice or testing of this disclosure, suitable methods and materials are described below. The term “comprises” means “includes.” The abbreviation, “e.g.”, is derived from the Latin exempli gratia, and is used herein to indicate a non-limiting example. Thus, the abbreviation “e.g.” is synonymous with the term “for example.”

To the extent not already indicated, it will be understood by those of ordinary skill in the art that any one of the various embodiments herein described and illustrated may be further modified to incorporate features shown in any of the other embodiments disclosed herein.

1. An expert intelligence system for supplementing CRM platform data by generating automated assessment of interactions between one or more members of a sales team and prospective customers based on data stored within a CRM platform, the system implemented using one or more microprocessors within a network-connected first computing platform, comprising:
CRM interface logic configured to read CRM data from, and write data to, a network-connected CRM computing platform, said CRM data comprising records characterizing sales team member activities associated with one or more sales opportunities;
a data storage system configured to store said CRM data procured by the CRM interface logic; and
evaluation logic applying the cleansed CRM data to a plurality of data models to generate and output an automated assessment of each of said sales opportunities;
wherein the plurality of data models comprise: (a) a macro model predictive of automated assessment components comprising opportunity time until close and opportunity revenue; and (b) a micro model predictive of automated assessment components comprising when a sales opportunity will change state within a predetermined sales pipeline model.

2. The expert intelligence system of claim 1, wherein the CRM interface logic is further configured to transmit the automated assessment output from the evaluation logic back to the CRM computing platform for storage therein.

3. The expert intelligence system of claim 1, in which:
the data cleansing logic is further configured to output a sales opportunity vector by vectorizing a subset of the CRM data associated with a particular sales opportunity; and
the evaluation logic is further configured to apply the sales opportunity vector to one or more of said data models.

4. The expert intelligence system of claim 1, wherein the CRM data comprises contact records, opportunity summaries, sales team members, call transcripts, email communications and opportunity notes.

5. The expert intelligence system of claim 1, wherein the data models comprise: one or more human expert models having predetermined fixed weights, for recommendation of actions to promote a positive change of state within a predetermined sales pipeline model.

6. The expert intelligence system of claim 1, wherein the data models comprise:
one or more machine models trained via machine learning based on historical CRM data;
one or more human expert models having predetermined fixed weights, for recommendation of actions to promote a positive change of state within a predetermined sales pipeline model; and
an ensemble model having weights determined at least in part based on outputs from the one or more machine models and the one or more human expert models.

7. The expert intelligence system of claim 1, further comprising application logic configured to periodically train one or more of said data models based on updated historical CRM data retrieved from said network-connected CRM computing platform.

8. The expert intelligence system of claim 1, wherein the evaluation logic applies the cleansed CRM data to the data models on a periodic basis.

9. A method for automated generation of sales opportunity performance assessment data by a network-connected sales support computing platform, for one or more sales opportunities associated with a sales team, the method comprising:
retrieving historical CRM data by a network-connected first computing platform, from a network-connected second computing platform comprising a CRM, the historical CRM data comprising a plurality of transaction records, each transaction record associated with a completed sales opportunity and characterizing an activity undertaken by a sales team in connection with an associated completed sales opportunity; the historical CRM data further comprising a success indicator associated with each of said sales opportunities indicating whether each of the completed sales opportunities was successful;
vectorizing the historical CRM data on a per opportunity basis to generate, and store on the first computing platform, vectorized historical CRM data;
training a plurality of machine learning models using the vectorized historical CRM data, each of the models predictive of future events in connection with a sales opportunity, the models comprising:
a macro model predictive of sales opportunity time until close and opportunity revenue; and
a micro model predictive of when a sales opportunity will change state within a predetermined sales pipeline model;
retrieving, from the second computing platform, current CRM data comprising records associated with one or more in-process sales opportunities;
vectorizing the current CRM data to generate, and store on the first computing platform, vectorized current CRM data;
calculating, by the first computing platform, a plurality of automated assessment components by:
applying the vectorized current CRM data to the macro model to generate macro sales opportunity data indicative of predicted time until close and predicted opportunity revenue for the one or more in-process sales opportunities, and
applying the vectorized current CRM data to the micro model to generate predicted pipeline change data indicative, for each of the one or more in-process sales opportunities, of predicted state change within a predetermined pipeline model; and
supplementing the current CRM data within the second computing platform by transmitting, for each of said in-process sales opportunities, from the first computing platform to the second computing platform, said macro sales opportunity data and said predicted pipeline change data, for storage by the second computing platform within one or more fields associated with said in-process sales opportunities.

10. The method of claim 9, further comprising:
for each in-process sales opportunity, applying (a) current CRM data records associated with the in-process sales opportunity, and (b) one or more of the automated assessment components associated with the in-process sales engagement, to a large language model to generate and output a natural language performance assessment for each of said in-process sales opportunities.

11. The method of claim 10, wherein supplementing the current CRM data comprises transmitting, for each of said in-process sales opportunities, from the first computing platform to the second computing platform, the natural language performance assessment.

12. The method of claim 9, further comprising:
applying a subset of the current CRM data associated with a first salesperson, and the natural language performance assessments for in-process sales opportunities associated with the first salesperson, as inputs to a large language model, to generate and store by the first computing platform an overall performance evaluation for the first salesperson.

13. The method of claim 9, wherein said macro sales opportunity data further comprises one or more sales team activity recommendations.
